(19) United States
(12) Patent Application Publication
(10) Pub. No.: US 2002/0074396 A1
(43) Pub. Date: Jun. 20, 2002

(54) Method and apparatus for linking printed matter to electronic media

(76) Inventors: Spencer A. Rathus, Short Hills, NJ (US); Lois Fichner-Rathus, Short Hills, NJ (US); Jeffrey S. Nevid, New York, NY (US)

Correspondence Address: Ward & Olivo, Suite 300, 382 Springfield Avenue, Summit, NJ, 07901, US

(21) Appl. No.: 09/950,037

(22) Filed: Sep. 10, 2001

Related U.S. Application Data
(63) Continuation-in-part of application No. 09/315,478, filed on May 20, 1999.
Application No. 09/315,478 is a continuation of application No. 08/618,246, filed on Mar. 18, 1996.

(51) Int. Cl. G06K 5/00

(52) U.S. Cl. 235/380

(57) ABSTRACT

A method for linking a printed matter to digital media is disclosed wherein links are provided throughout the printed matter and reference electronic media relating to the printed matter. The links are entered manually into a software program on a computer or other device for accessing electronic media via a keyboard or mouse and function to open digital media stored on a CD-ROM, DVD, the computer's hard drive, the Internet or a website, or other digital storage source.

### CROSS REFERENCE TO OTHER APPLICATIONS

This application is a continuation-in-part of U.S. Ser. No. 09/315,478 filed on May 20, 1999 now U.S. Pat. No. 6,164,534, which is a continuation application of U.S. Ser. No. 08/618,246 filed Apr. 4, 1996 now U.S. Pat. No. 5,932,863.

### TECHNICAL FIELD OF THE INVENTION

The disclosed methods and apparatus relate generally to the electronics media industry and more particularly to media presented in printed matter form, such as books, newspapers, magazines, catalogs, pamphlets and the like. These methods and apparatus further allow a user to access and make use of electronic media, including media stored on a CD-ROM-based multi-media applications, an internet based application, world-wide-web based applications, a digital video disk based application and the like via entry of data set forth by the printed media.

### BACKGROUND OF THE INVENTION

Information is often presented in many forms. For example, information may be presented to individuals in printed form such as a newspaper, a weekly catalogue, a monthly magazine, a bi-annual report or numerous other forms of media. It is well known in the art that a person may access information in a multitude of ways and for numerous purposes, including, for example, obtaining information for educational purposes, business purposes, and entertainment purposes. As a result of the long-felt need for accessing information, the multitude of formats for presenting information and the numerous purposes for utilizing printed matter to obtain information, various advancements for improving the flow of information have been presented for altering the manner in which printed information may be conveyed.

One of the most prominent advancements for improving the flow of information in recent times has been the advent of the world-wide-web and the widespread proliferation of personal computers. With the advent of the world-wide-web and the worldwide proliferation of personal computers, digital data has become highly accessible. This technology permits the transfer and instant delivery of a virtually limitless selection of commercial, educational and entertainment related information to a user. However, the high-bandwidth transfer of digital data to millions of homes has still not made the utilization of information contained in printed matter obsolete. Therefore, there still exists a need for accessing the vast resources of electronic media using a method and apparatus that still employs common printed matter.

Several techniques have evolved that attempt to merge the expanding electronic media resources with a vast array of printed media. For example, the prior art includes a class of devices known as “talking books”—see, e.g., U.S. Pat. No. 4,636,881 entitled TALKING BOOK WITH AN INFRARED DETECTOR USED TO DETECT PAGE TURNING, U.S. Pat. No. 4,702,573 entitled VISUAL AND AUDIBLE ACTIVATED WORK AND METHOD OF FORMING SAME, U.S. Pat. No. 4,778,391 entitled SOUND-PRODUCING AMUSEMENT OR EDUCATIONAL DEVICES, U.S. Pat. No. 4,809,246 entitled SOUND ILLUSTRATED BOOK HAVING PAGE INDICATOR CIRCUIT, U.S. Pat. No. 4,990,092 entitled TALKING BOOK and U.S. Pat. No. 5,209,665 entitled INTERACTIVE AUDIO VISUAL WORK, all of which are incorporated herein by reference. Typically, these “talking books” consist of a book with various sensors which—when activated by touching, page turning, etc.—cause a sound generating means (also embedded within the book) to produce or replay particular sounds. Talking books, thus, provide an interface for allowing an unsophisticated user (i.e., a child) to access a very primitive computer (i.e., the sound generating means embedded within the book) via familiar printed matter (i.e., the book with embedded sensors). However, talking books do not utilize the advantages known in the art for accessing electronic media and do not provide a means for interfacing with modern electronic media, such as CD-ROM-based multi-media applications, Internet applications or websites, and digital video disks (DVDs).

Another method known in the art for bridging printed matter with electronic media has been the implementation of software bundled with the printed matter. For example, it is known in the art to provide software applications bundled with a textbook. By loading the software on a personal computing device, a user may access additional electronic material. However, such devices fail to provide a simplified means for directly accessing electronic media and do not provide a means for interfacing with modern electronic media, such as CD-ROM-based multi-media applications, Internet applications or websites, and digital video disks (DVDs).

Another approach for interfacing printed matter with electronic media is disclosed in Rathus et al. U.S. Pat. No. 5,932,863 and Rathus et al. U.S. Pat. No. 6,164,534, which are incorporated herein by reference. Rathus et al. U.S. Pat. No. 5,932,863 and Rathus et al. U.S. Pat. No. 6,164,534 disclose methods and apparatus for allowing a user to access and make use of electronic media input and output devices by reference to and/or utilization of standard printed matter, such as magazines, textbooks, or any other printed matter that can be correlated to electronic media.

Another approach to interfacing with modern electronic media is the “simulated book”—see, e.g., U.S. Pat. No. 4,855,725, entitled MICROPROCESSOR BASED SIMULATED BOOK, incorporated herein by reference. The “simulated book” is in essence a book-size intelligent graphics terminal. Unlike the talking books, the simulated book is not a self-contained system, but rather transmits commands to and receives data from a CD-ROM equipped personal computer via a wireless link. Thus, the programming that the simulated book can access is not limited to that which can be stored in embedded memory devices, as with the talking books.

A disadvantage of the talking book and the simulated book technologies is that both include relatively costly electronics—i.e., microprocessors, memory, display devices, etc., as a part of the “book.” Thus, these technologies cannot be effectively used to create a “throw-away” interactive magazine, newspaper or advertising brochure. Furthermore, these technologies do not provide access to the widespread dissemination of information that is available in all forms of electronic media.

Thus, there remains a need for a method and apparatus for utilizing the vast resources of electronic media to provide additional material that may relate to particular sections, chapters, topics and the like set forth in printed matter. Furthermore, there remains a need for a means for linking printed matter to electronic media wherein the link results in minimal or no additional expense to the manufacturer of the printed medium. Still further, there remains a need for providing electronic media links associated with all types of printed matter, including, but not limited to books, newspapers, magazines, and pamphlets.

### SUMMARY OF THE INVENTION

An object of the present invention is to provide a method for linking printed media to electronic media. For example, in one embodiment of the present invention, printed matter with organized sections is provided with link indications on a plurality of sections or pages. The link indications, for example, may comprise an alphanumeric code or other symbol such as a graphic display, an icon, or other similar image. The link indications may refer to material either on a CD-ROM, DVD, computer's hard drive, an Internet file or a website. By entering the link information into a multi-media accessible device, the link indications may provide a conduit to additional material, including visual presentations, audio presentations, slide shows, supplemental text, example questions or quizzes, sample solutions, further explanations of relevant material or other relevant electronic media. In operation, the user accesses the desired electronic media (i.e., for example, CD-ROM, world-wide-web, DVD or the like) on a computer, a web-enabled cellular telephone, an internet appliance, a personal digital assistant or other similar device for accessing electronic media and enters a code link in accordance with the printed matter. For example, the code link may comprise an indication of the electronic medium to be accessed, followed by a chapter, followed by a page, followed by a question. Therefore, in this example, it requires four “keystrokes” to be entered by the user to access the desired information. The code link may be entered by means of a keyboard, mouse, or other commonly available input device (i.e., “keystrokes,” “clicks,” “swipes,” etc.). Upon entering the code link, a file is opened that supplements information contained within the printed matter.

The linking method of the present invention can easily be appreciated when realizing the limitations authors and publishers encounter when providing sufficient material to a user of printed matter. For example, in the textbook publishing arena, an author may desire to provide a substantial amount of text related to the topics set forth in a textbook. However, a publisher may be reluctant to provide all the desired text set forth in numerous cited references and the like due to page number constraints or page size limitation. In addition, an author may desire to include visual presentations, audio presentations, slide shows, quizzes, web links or other audio-visual-type information. Of course, it is well known in the art that the implementation of such electronic media within a printed matter is not feasible. Therefore, it is clear that it is impossible, or often impractical, to include the supplemental electronic media desired for explaining certain material within a textbook. It is also impractical, both for publishers due to expense, as well as for students due to the increased, unnecessary weight and size of a text. By utilizing digital media (such as media contained on currently available CD-ROMs, DVDs, and the Internet, world wide web or the like) a textbook of reasonable size may more closely cover all of the relevant points the author desires to cover if a user is able to easily access related electronic media. In addition, a textbook may also include supplemental information that may aid in the understanding of a topic including various tutorial aids in the form of audio/visual media and interactive quizzes or tests. Additionally, the printed matter may be provided with a plurality of links that do not significantly increase the cost of printing the pages.

In addition to textbooks, the above method of linking may also be adapted for any other form of printed matter such as newspapers, magazines, pamphlets, novels, and the like. Also, it is foreseeable that the method and apparatus disclosed herein may link a user to electronic media including, but not limited to advertising material, information relating to other textbooks or printed matter and other digital matter such as links, programs, and files.

Digital media utilized with the present invention may be provided by the publisher, or alternate source, in one or more of a multiple of forms, including, but not limited to a CD-ROM, DVD, or through Internet or website means. A program and/or number of files provided by any of the above means may be installed (either temporarily or permanently) or copied onto the user's hard drive or other storage device. Alternatively it is foreseeable that the data may be copied and stored on an alternate type of electronic media for use by the user on an alternate system. In the case of the Internet, one or more files may be downloaded onto the user's computer or other device for accessing electronic media and then installed (either temporarily or permanently) and/or referenced during operation. It is also foreseeable, that once the program and/or files are available to the user of the computer or other device, the user may use stored data located within the storage means of the computer in place of a CD-ROM, DVD, or other external media means as a source for the links.

In another aspect of the present invention, an icon may be created on a computer's desktop that links to the interface program. It is foreseeable, that an icon may allow the user to initiate the linking method of the present invention with one or two clicks, keystrokes, or the like of a mouse, keyboard or other control device capable of inputting data. For example, if a CD-ROM or DVD is used as the digital source for the link the interface program may automatically open upon insertion of the disk into the computer's disk drive.

Thus, it is an object of the present invention to provide a simplified method and apparatus for linking printed matter to electronic media.

It is a further object of the present invention to provide a method and apparatus for linking printed matter to digital media wherein the links can be printed on all printed matter inexpensively.

It is an additional object of the present invention to provide a method and apparatus for linking printed matter to digital media wherein the links to the information may be displayed to a user in a concise manner and set forth on specific portions of the printed matter.

It is still a further object of the present invention to provide a method and apparatus wherein links are placed throughout at least a portion of a printed matter for referencing supplemental digital media relating to specific portions of the printed matter.

It is an additional object of the present invention to provide a method and apparatus for linking printed matter to digital media wherein a user may access electronic media by entering a series of “keystrokes” to reach the desired portion of the media.

It is still a further object of the present invention to provide a method and apparatus for linking printed matter to digital media wherein a user may access electronic media by entering a series of “clicks” of a mouse device to reach the desired portion of the electronic media.

It is yet a further object of the present invention to provide software that can be installed on a computer to allow the user to enter links found in printed matter using a keyboard, mouse, or other commonly available input device to directly access particular digital media.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts an embodiment of a page of printed text of the present invention with a single code link;

FIG. 2 depicts an embodiment of a page of printed text of the present invention with a code link comprising a plurality of characters;

FIG. 3 depicts an embodiment of the present invention wherein depicted is a window display of a software program comprising a single code link entry box;

FIG. 4 depicts an embodiment of the present invention wherein a window display is depicted comprising code link indicia and an associated code link indicia box for inputting desired electronic navigation address data;

FIG. 5A depicts an embodiment of the present invention wherein a window display is depicted comprising code link indicia, scrollable entry keys and an associated code link indicia box for inputting desired electronic navigation address data;

FIG. 5B depicts an embodiment of the present invention as set forth in FIG. 5A wherein a window display is depicted providing additional information associated with the inputted code link indicia;

FIGS. 6A, 6B and 6C depict an embodiment of the present invention wherein a series of window displays are depicted providing a step-by-step display of the information presented to a user wherein a user is able to access desired electronic media associated with a printed textbook;

FIGS. 7A, 7B and 7C depict an embodiment of the present invention wherein a series of window displays are depicted providing a step-by-step display of the information presented to a user wherein a user is able to access desired electronic media associated with a printed periodical; and

FIGS. 8A, 8B and 8C depict an embodiment of the present invention wherein a series of window displays are depicted providing a step-by-step display of the information presented to a user wherein a user is able to access desired electronic media associated with a printed newspaper.

### DETAILED DESCRIPTION OF THE INVENTION

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims set forth herein which define the scope of the present invention. The following presents a detailed description of a preferred embodiment (as well as some alternative embodiments) of the present invention.

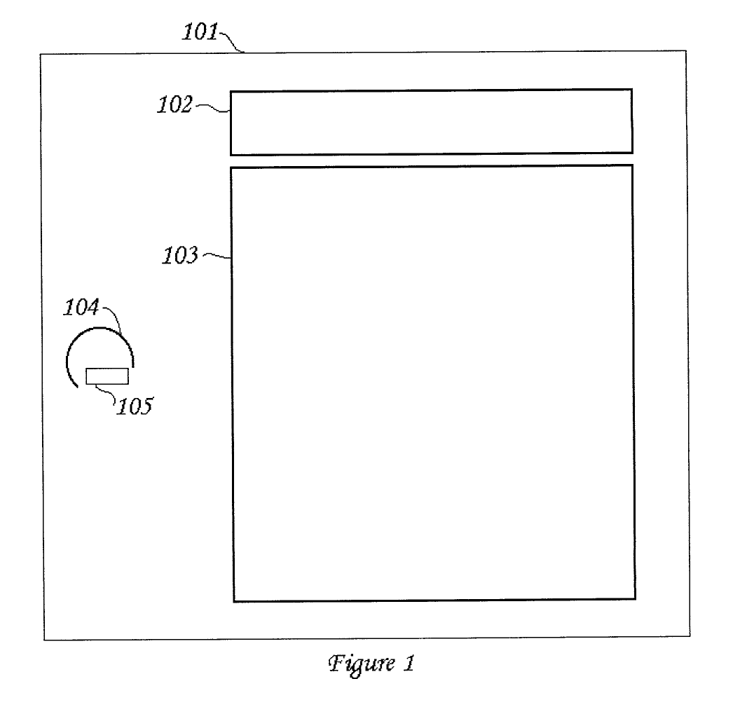

Referring first to FIG. 1, shown is a section or page 101 of printed matter with a link code 105. Link codes 105 may be located at any location on a printed matter, including, but not limited to the beginning, end, or at various significant points throughout a given section or chapter. For example, in FIG. 1, box 102 comprises a page or section heading and box 103 comprises body text. Variations of the layout of this page 101 may be utilized to accommodate different printed matter formats. In accordance with one embodiment, a printed matter may be provided that comprises a plurality of sections or pages 101, each with a plurality of link codes 105. Link indications 104 are provided to accentuate link codes 105 and text may be written alongside these link indications 104 to describe the media corresponding to the link codes 105.

In operation, the link code 105 provides specific information for directing a user to a specific electronic media. For example, a user may be directed to a specific web-page at a specific web-address accessible via the world-wide-web. Upon accessing the page the user may access additional information on the web page and may be further directed to a specific question within the website. Although a user may access the desired electronic media by any known digital input means, in addition to those digital input means not yet contemplated, in this embodiment of the present invention it is recommended that the user enters the link code 105 into a computer by striking at least one key of a keyboard (not shown) or by clicking at least one button of mouse-type device (not shown). Although it is contemplated in the present invention that the digital input means comprise a standard computer keyboard or a digital mouse, numerous other forms of digital input means may be employed, including, but not limited to a twelve-digit telephone keypad, a personal digital assistant keypad, an optical mouse or a personal computer camera. For simplicity, the link code 105 may contain a character that classifies what type of material the link code 105 refers to, such as audio/video, text, or interactive media. In one example of the embodiment, one character of link code 105 may be ‘v’ for video, ‘r’ for reference, ‘g’ for glossary, ‘t’ for test or ‘q’ for quiz. A second character of the link code 105 may represent the source of the digital media to be accessed. For example, ‘c’ may refer to a link on a CD-ROM, ‘d’ may refer to a DVD, ‘h’ may indicate a hard drive, or ‘w’ may refer to the Internet or world-wide-web. These character references within the link code 105 may be either predetermined by a software application or may be user-assignable by means of a look-up table or other feature utilized to achieve the desired operation for the user. The link code 105 may also comprise additional characters including section or chapter indications. For example, the combination of ‘1.1.1.a’ may refer to chapter 1, section 1, question/comment 1, part a. Using the previous three examples, a complete link code 105 referring to a particular video file on a CD-ROM relating to a point raised in ‘chapter 1, section 1, comment 1, part a’ of a book may be ‘v.c.1.1.1.a’. Another variation of this link code 105 may be, for example, ‘v0135’ which may refer to a thirty-fifth video link from chapter one. An additional example may be ‘q1504’ which may refer to a fourth quiz in chapter 15. Many other variations of this linking method may also be employed to achieve similar results. For example, in this embodiment, if a user is reading a textbook and has a question or is interested in learning more about a specific subject, the user may utilize an associated link code 105 allowing the user to simply enter the link code 105 relating to the desired material. By entering the desired link code 105, an intelligent processor may automatically open a file on a textbook CD-ROM, DVD, the user's hard drive, or open an internet file or a website. Because the link code 105 is in accordance with a logically organized system, the user can link to a variety of related media with minimal difficulty.

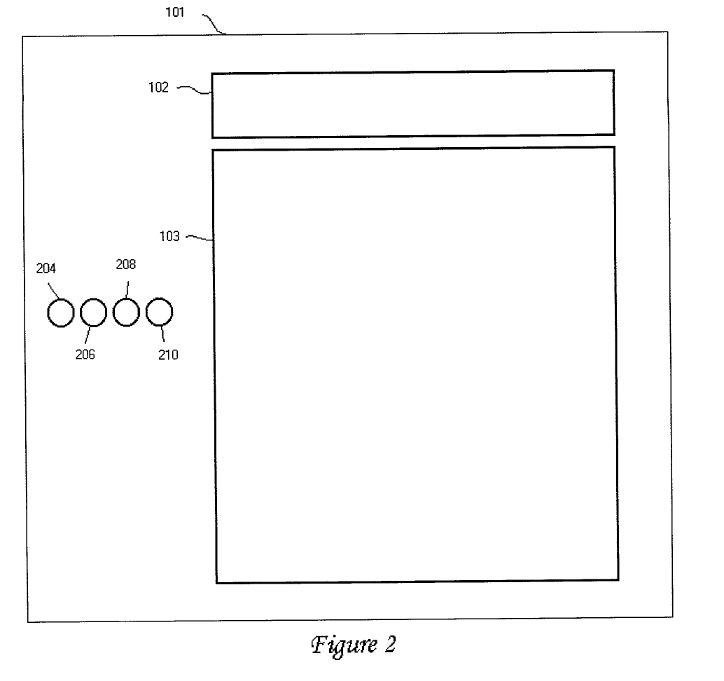

Referring next to FIG. 2, depicted is a section or page 101 of printed matter with a heading box 102 and body text box 103 comprising a link configuration and associated link indicia 204, 206, 208 and 210. In this embodiment, depicted are a series of four link indicia 204, 206, 208 and 210, however, it is contemplated that more or less link indicia may be employed while still achieving the desired novelty of the present invention. In this embodiment, each link indicia 204, 206, 208 and 210 functions as a single character in a similar manner as depicted by link code 105 described in FIG. 1 (not shown). However, in the present embodiment of the invention, the distinct link indicia 204, 206, 208 and 210 allow a user to more readily determine distinct characters associated with the link code. Furthermore, it is foreseeable that each link indicia 204, 206, 208 and 210 may be color-coded, presented in a series of different fonts or conveyed in another form which provides for improved distinction.

In this embodiment of the present invention, a user may input the information provided by the link indicia 204, 206, 208 or 210 into an intelligent controller. For example, a user may be directed to a specific web page at a specific web-address accessible via the world-wide-web. Upon accessing the page the user may access additional information on the web page and may be further directed to a specific question or database contained within the website. Although a user may access the desired electronic media by any known digital input means, in addition to digital input means not yet contemplated, in this embodiment of the present invention it is recommended that the user enters the link code 105 into a computer by striking at least one key of a keyboard (not shown) or by clicking at least one button of mouse-type device (not shown). Although it is contemplated in the present embodiment of the invention that the digital input means comprise a standard computer keyboard or a digital mouse, numerous other forms of digital input means may be employed, including, but not limited to a twelve-digit telephone keypad, a personal digital assistant keypad, an optical mouse or a personal computer camera. For simplicity, the link indicia 204, 206, 208 and 210 may comprise a series of data that classifies the type of material the link indicia 204, 206, 208 and 210 refer to, such as audio/video, text, or interactive media. In this embodiment, it is foreseeable that link indicia 204 may represent the digital media source. For example link indicia 204 may denote the symbol “www” for world-wide-web, “cod” for CD-ROM, or other like electronic media. Next, link indicia 206 may denote a numeral, such as “2” for chapter two, “3” for page three, or other similar designations. Link indicia 208 may represent “BBC” for bulletin board chat, “PS” for primary sources, “E” for essay assignments, “WS” for web-search activities, “L” for web-links, “Q” for quizzes, “FC” for flash cards, “V” for video animations, “SA” for self-assessments, or other like descriptors for accessing additional related information. Finally, the fourth link indicia 210, may comprise an additional descriptor to direct the user to a desired point within the desired section to which the user is directed. For example if a user is presented with a printed matter comprising a first link indicia 204 of “www,” a second link indicia 206 of “12,” a third link indicia 208 of “V” and a fourth link indicia 210 of “4”, it is readily apparent that the user is directed to access the world-wide-web, chapter twelve, video number four.

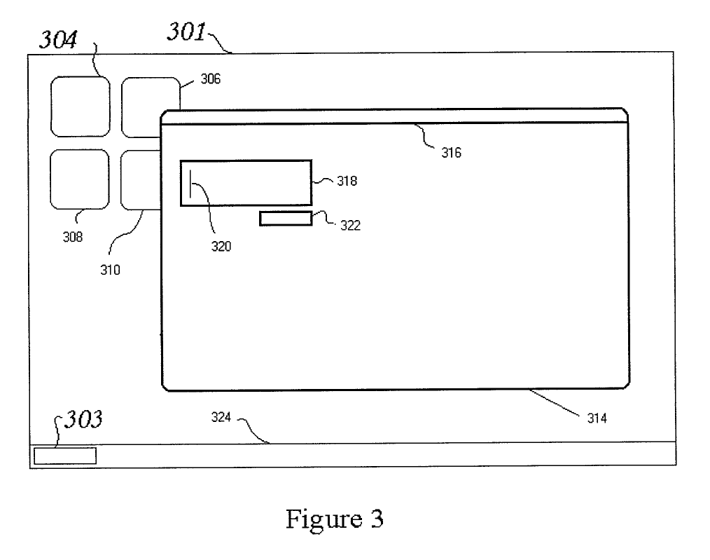

Referring next to FIG. 3, depicted is a window display 314 of a software program used in the present invention opened in conjunction with a typical computer display screen 301 commonly utilized in the art. The computer display screen 301 comprises icons 304, 306, 308 and 310, menu bar 324, and menu button 303 as found in most user-friendly computer operating systems wherein a mouse (not shown) provides the user with simplified control of a multitude of computer functions. By clicking on at least one of icons 304, 306, 308 and 310 with a mouse-type device, a user may be able to access an electronic medium. The window display 314 comprises a menu application bar 316 and a code link entry box 318, which further comprises a cursor 320 for inputting data therein. An enter dialog box 322 may also be provided for accessing the desired data inputted in the code link entry box 318. Alternatively, upon insertion of a requisite number of characters in the code link entry box 318, the intelligent controller may be programmed to access the desired information without the use of the enter dialog box 322 command. By entering the information set forth in the code link 105 of FIG. 1 or the link indicia 204, 206, 208 and 210 of FIG. 2 into code link entry box via a keyboard of other like input means, the computer program is directed to access the desired information.

For example, a user may be directed to a specific type of electronic media such as a DVD. Upon inserting the DVD into an intelligent reading device, the user may instruct the intelligent controller to access a specific portion of information stored on the DVD. Although a user may access the desired electronic media by any known digital input means, in addition to those digital input means not yet contemplated, in this embodiment of the present invention it is recommended that the user enters the link code into the code link entry box 318 of the personal intelligent controller by striking at least one key of a keyboard (not shown) or by clicking at least one button of mouse-type device (not shown). Although it is contemplated in the present invention that the digital input means comprise a standard computer keyboard or a digital mouse, numerous other forms of digital input means may be employed, including, but not limited to a twelve-digit telephone keypad, a personal digital assistant keypad, an optical mouse or a personal computer camera. In one example of this preferred embodiment, one character of the link code may be ‘v’ for video, ‘r’ for reference or ‘g’ for glossary. A second character of the link code may represent the source of the digital media to be accessed. For example, ‘c’ may refer to a link on a CD-ROM, ‘d’ may refer to a DVD or ‘h’ may indicate a hard drive. These character references comprising the link code may be either predetermined by the software or may be user-assignable by means of a look-up table or other software feature utilized to achieve the desirable operation for the user. The link code may also comprise additional characters including section or chapter indications. For example, the combination of ‘1.2.3.c’ may refer to chapter 1, section 2, question/comment 3, part c. Using the previous three examples, a complete link code referring to a particular video file on a CD-ROM relating to a point raised in ‘chapter 1, section 2, question/comment 3, part c’ of a book may be ‘v.c.1.2.3.c’. Another variation of the link code may be, for example, ‘v0135’ which may refer to a thirty-fifth video link from chapter one. An additional example of the link code may be ‘q1504’ which may refer to a fourth quiz in chapter 15. Many other variations of this linking method may also be employed to achieve similar results. For example, the link codes may comprise a simple data entry of the page number of the printed matter and a specific item number within the page of the printed matter. However, it is also contemplated that the link codes may comprise any series of structured characters. For example, in this method, if a user is reading a newspaper and has a question or is interested in learning more about a specific subject or an article, the user may utilize an associated link code allowing the user to simply enter the link code digits relating to the desired material. By entering the desired link code, an intelligent processor may automatically open a file on a textbook CD-ROM, DVD, the user's hard drive, or open an internet file or a website. Because the link code is in accordance with a logically organized system, the user can link to a variety of related media with minimal difficulty.

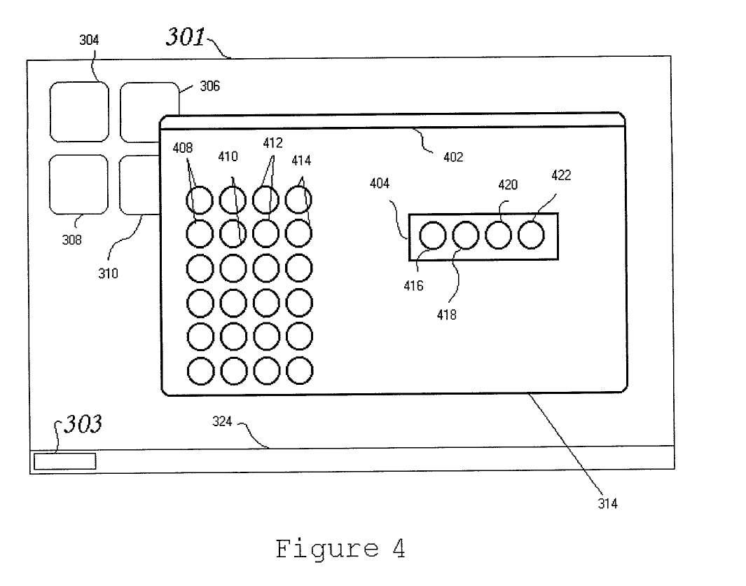

Referring next to FIG. 4, depicted is a window display 314 of a software program used in the present invention opened in conjunction with a typical computer display screen 301 commonly utilized in the art. The computer display screen 301 comprises icons 304, 306, 308 and 310, menu bar 324, and menu button 303 as found in most user-friendly computer operating systems wherein a mouse (not shown) provides the user with simplified control of a multitude of computer functions. By clicking on at least one of icons 304, 306, 308 and 310 with a mouse-type device, a user may be presented with an overlay screen, separate pop-up screen or other like screen such as window display 314. The window display 314 may represent information provided by a CD-ROM, a DVD, the Internet, or other like electronic media. Specifically, the window display 314, comprising a menu application bar 402, provides a multitude of navigation indicia 408, 410, 412 and 414 for providing navigational means allowing a user to access information. Specifically, navigation indicia 408, 410, 412 and 414 correlate to link indicia set forth in a printed matter. Link indicia (not shown) of a printed matter may include a series of informational input for directing a user to a specific portion of an electronic media. For example, the link indicia set forth in a printed matter may comprise a series of data that classifies the type of material the link indicia refer to, such as audio/video, text, or interactive media. A first link indicia may denote the symbol “www” for world-wide-web, “cd” for CD-ROM, or other like electronic media. A second link indicia may denote a numeral, such as “2” for chapter two, “3” for page three, or other similar designations. Subsequently a third link indicia may represent “BBC” for bulletin board chat, “PS” for primary sources, “E” for essay assignments, “WS” for web-search activities, “L” for web-links, “Q” for quizzes, “FC” for flash cards, “V” for video animations, “O” for outline, “SA” for self-assessments, or other like descriptors for accessing additional related information. Finally, a fourth link indicia may comprise an additional descriptor to direct the user to a desired point within the desired section to which the user is directed.

For example, if a user locates a series of link indicia set forth in a printed matter, the user may compare the link indicia to the navigation indicia 408, 410, 412 and 414 set forth on the window display 314 of the intelligent controller. Specifically, the first set of navigation indicia 408 set forth on the window display 314 may include a symbol denoting “www” for world-wide-web, “cd” for CD-ROM, or other like electronic media. The second set of navigation indicia 410 set forth on the window screen 314 may denote a numeral, such as “2” for chapter two, “3” for page three, or other similar designations. Subsequently a third set of navigation indicia 412 set forth on the window screen 314 may represent “BBC” for bulletin board chat, “PS” for primary sources, “E” for essay assignments, “WS” for web-search activities, “L” for web-links, “Q” for quizzes, “FC” for flash cards, “V” for video animations, “SA” for self-assessments, or other like descriptors for accessing additional related information. Finally, a fourth set of navigation indicia 414 may comprise an additional descriptor to direct the user to a desired point within the desired section to which the user is directed.

Therefore, if a user is presented with a link indicia in a form of printed matter such as “CD-ROM,” “5,” “E,” “4” the user may, for example, utilize a mouse to “click” on the corresponding navigation indicia 408, 410, 412 and 414. Specifically, the user may locate and “click” on the “CD-ROM” label among one of the set of navigation indicia 408. Next the user may locate and “click” on the “5” label among one of the set of navigation indicia 410. Subsequently, the user may locate and “click” on the “E” label among one of the set of navigation indicia 412. Finally, the user may locate and “click” on the “4” label among one of the set of navigation indicia 414. As each input of the navigation indicia 408, 410, 412, 414 is accessed by the user via the input means (i.e., the “click” of the mouse), it is foreseeable that the desired navigation indicia 408, 410, 412, 414 may be highlighted or potentially displayed on another portion of the window display 314. For example, it is foreseeable that window display 314 may include a navigation link entry box 404 for displaying the desired navigation indicia 408, 410, 412 and 414 (i.e., navigation link entry box 404 may depict navigation indicia 408 displayed in navigation link entry 416, navigation link entry box 404 may depict navigation indicia 410 displayed in navigation link entry 418, navigation link entry box 404 may depict navigation indicia 412 displayed in navigation link entry 420 and navigation link entry box 404 may depict navigation indicia 414 displayed in navigation link entry 422). Thereby, navigation entry box 404 may display “CD-ROM” as navigation link entry 416, “5” as navigation link entry 418, “E” as navigation link entry 420 and “4” as navigation link entry 422. Upon completion of a sufficient display of address location in navigation entry box 404, the intelligent controller may access the desired location on the electronic media. Although the present embodiment provides an address structure consisting of four distinct link indicia and corresponding set of navigation indicia 408, 410, 412 and 414, it is foreseeable that any series of input may be employed such as an electronic media address of one, two, three or more specific portions for accessing a desired location. In addition, it is foreseeable that a desired location on an electronic media may be reached incrementally wherein upon inputting a first navigation indicia 408, the user may be directed to a first location of a portion of desired address (i.e., a user simply access the world-wide-web by simply inputting a first navigation link only). Furthermore, although it is preferred that the user “click” on the desired navigation indicia 408, 410, 412 and 414 in the order set forth in the printed matter, it is foreseeable that each navigation indicia 408, 410, 412 and 414 may comprise specific individual attributes thereby allowing a user to “click” on each navigation indicia 408, 410, 412 and 414 in any order desired without compromising access to the desired location in the electronic media.

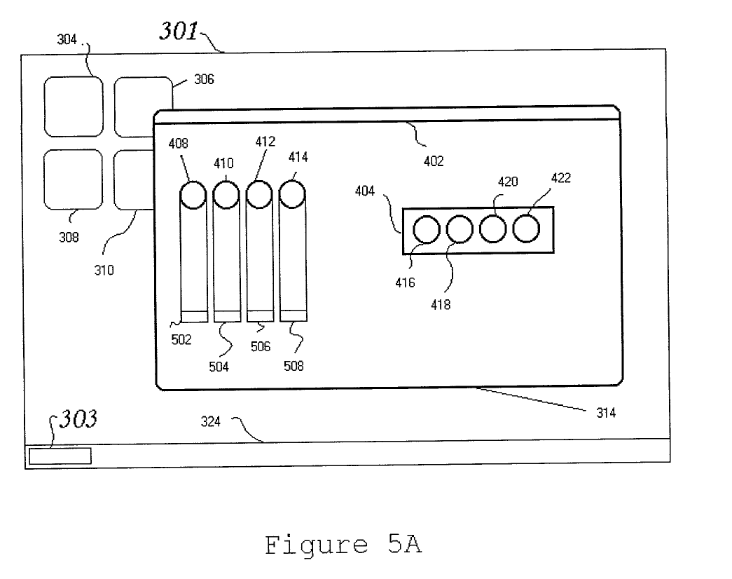

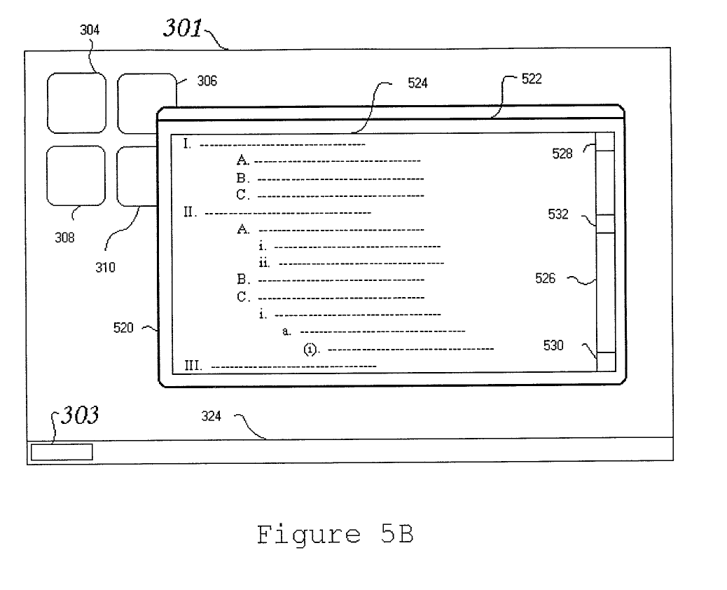

Referring next to FIG. 5A, depicted is a window display 314 of a software program used in the present invention opened in conjunction with a typical computer display screen 301 commonly utilized in the art. The computer display screen 301 comprises icons 304, 306, 308 and 310, menu bar 324, and menu button 303 as found in most user-friendly computer operating systems wherein a mouse (not shown) provides the user with simplified control of a multitude of computer functions. By clicking on at least one of icons 304, 306, 308 and 310 with a mouse-type device, a user may be presented with an overlay screen, separate pop-up screen or other like screen such as window display 314. The window display 314 may represent information provided by a CD-ROM, a DVD, the Internet, or other like electronic media. Specifically, the window display 314, comprising a menu application bar 402, provides navigation indicia 408, 410, 412 and 414 for providing navigational means allowing a user to access information. Specifically, navigation indicia 408, 410, 412 and 414 correlate to link indicia (not shown) set forth in a printed matter. Navigation indicia 408, 410, 412 and 414 may further comprise row navigation indicia scroll buttons 502, 504, 506 and 508 for allowing a user to scroll through a multitude of distinguishing navigation indicia 408, 410, 412 and 414. The configuration of navigation indicia 408, 410, 412 and 414 provided with navigation indicia scroll buttons 502, 504, 506 and 508 may provide for improved space utilization on the window display 314 therefore improving the configuration of window display 314. Link indicia (not shown) of a printed matter may include a series of informational input for directing a user to a specific portion of an electronic media. For example, the link indicia set forth in a form of printed matter may comprise a series of information that classifies the type of material the link indicia refer to, such as audio/video, text, or interactive media. A first link indicia may denote the symbol “www” for world-wide-web, “cd” for CD-ROM, or other like electronic media. A second link indicia may denote a numeral, such as “2” for chapter two, “3” for page three, or other similar designations. Subsequently a third link indicia may represent “BBC” for bulletin board chat, “PS” for primary sources, “E” for essay assignments, “WS” for web-search activities, “L” for web-links, “Q” for quizzes, “FC” for flash cards, “V” for video animations, “SA” for self-assessments, “O” for outline or other like descriptors for accessing additional related information. Finally, a fourth link indicia may comprise an additional descriptor to direct the user to a desired point within the desired section to which the user is directed.

For example, if a user locates a series of link indicia (not shown) set forth in a printed matter, the user may compare the link indicia to the navigation indicia 408, 410, 412 and 414 set forth on the window display 314 of the intelligent controller. Specifically, the first set of navigation indicia 408 set forth on the window display 314 may include a symbol denoting “www” for world-wide-web, “cd” for CD-ROM, or other like electronic media. The second set of navigation indicia 410 set forth on the window screen 314 may denote a numeral, such as “2” for chapter two, “3” for page three, or other similar designations. Subsequently a third set of navigation indicia 412 set forth on the window screen 314 may represent “BBC” for bulletin board chat, “PS” for primary sources, “E” for essay assignments, “WS” for web-search activities, “L” for web-links, “Q” for quizzes, “FC” for flash cards, “V” for video animations, “SA” for self-assessments, “O” for outline or other like descriptors for accessing additional related information. Finally, a fourth set of navigation indicia 414 may comprise an additional descriptor to direct the user to a desired point within the desired section to which the user is directed.

Therefore, if a user is presented with a link indicia in a form of printed matter such as “DVD,” “10,” “O,” “396” the user may, for example, utilize a mouse to “click” on and scroll through the corresponding navigation indicia 408, 410, 412 and 414. Specifically, the user may locate and “click” on the “DVD” label among one of the set of navigation indicia 408. Next the user may locate and “click” on the “10” label among one of the set of navigation indicia 410. Subsequently, the user may locate and “click” on the “O” label among one of the set of navigation indicia 412. Finally, the user may locate and “click” on the “396” label among one of the set of navigation indicia 414. As each input of the navigation indicia 408, 410, 412, 414 is accessed by the user via the input means (i.e., the “click” of the mouse), it is foreseeable that the desired navigation indicia 408, 410, 412, 414 may be highlighted or potentially displayed on another portion of the window display 314. For example, it is foreseeable that the window display may include a navigation link entry box 404 for displaying the desired navigation indicia 408, 410, 412 and 414 (i.e., navigation link entry box 404 may depict navigation indicia 408 displayed in navigation link entry 416, navigation link entry box 404 may depict navigation indicia 410 displayed in navigation link entry 418, navigation link entry box 404 may depict navigation indicia 412 displayed in navigation link entry 420 and navigation link entry box 404 may depict navigation indicia 414 displayed in navigation link entry 422). Thereby, navigation entry box 404 may display “DVD” as navigation link entry 416, “10” as navigation link entry 418, “O” as navigation link entry 420 and “396” as navigation link entry 422. Upon completion of a sufficient display of address location in navigation entry box 404, the intelligent controller may access the desired location on the electronic media (i.e., the three hundred ninety-sixth outline of the tenth chapter on the digital video disc electronic media). Although the present embodiment provides an address structure consisting of four distinct link indicia and corresponding set of navigation indicia 408, 410, 412 and 414, it is foreseeable that any series of input may be employed such as an electronic media address of one, two, three or more specific portions for accessing a desired location. In addition, it is foreseeable that a desired location on an electronic media may be reached incrementally wherein upon inputting a first navigation indicia 408, the user may be directed to a first location of a portion of desired address (i.e., a user simply access the world-wide-web by simply inputting a first navigation link only). Furthermore, although it is preferred that the user “click” on the desired navigation indicia 408, 410, 412 and 414 in the order set forth in the printed matter, it is foreseeable that each navigation indicia 408, 410, 412 and 414 may comprise specific individual attributes thereby allowing a user to “click” on each navigation indicia 408, 410, 412 and 414 in any order desired without compromising access to the desired location in the electronic media.

Referring next to FIG. 5B, depicted is the resulting display 520 subject to the input of the desired link data as described in FIG. 5A. Presented is an electronic display 520 comprising a menu bar 522, table of contents display 524, scroll bar 526, top scroll 528, bottom scroll 530, and scroll controller 532. The table of contents display 524 corresponds to the displayed information. Therefore, in accordance with the navigation indicia inputted in FIG. 5A, displayed is the three hundred ninety-sixth outline of the tenth chapter on the digital videodisc electronic media. Furthermore, the menu bar 522, table of contents display 524, scroll bar 526, top scroll 528, bottom scroll 530, and scroll controller 532 allow the user to scroll through the requested electronic media and potentially continue the desired inquiry with related text, audio-visual presentation and the like.

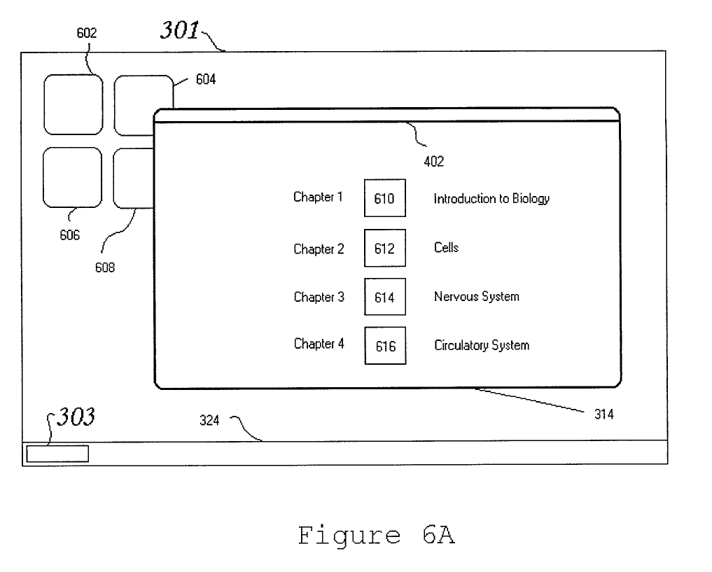

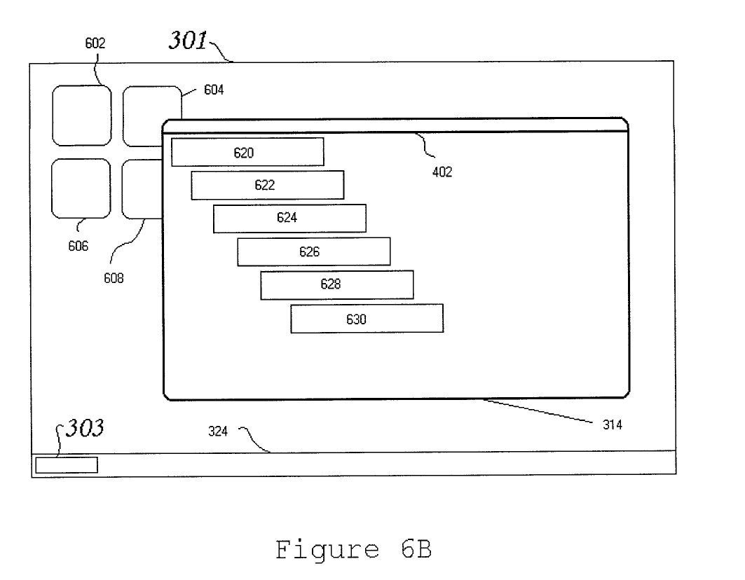

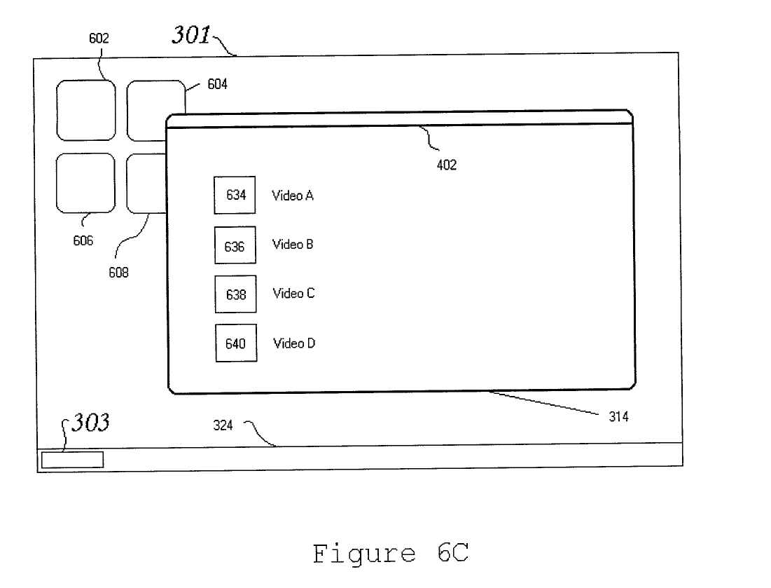

Referring next to FIGS. 6A, 6B and 6C, depicted is an alternate embodiment of the present invention pertaining to a printed textbook wherein computer display screen 301 comprises desktop icons 602, 604, 606 and 608, menu bar 324, and menu button 303 as found in most user-friendly computer operating systems wherein a mouse (not shown) provides the user with simplified control of a multitude of computer functions. As depicted in a corresponding printed matter, such as in this example a collegiate level textbook (not shown), a user is provided four indicia for direction to a desired electronic address for additional information relating to the text set forth in the printed matter. In this embodiment, desktop icons 602, 604, 606 and 608 consist of specific direct links to the desired sources of electronic media relating to the printed matter. For example, it is contemplated by the present embodiment of the invention that desktop icons 602, 604, 606 and 608 may be generated from a “favorites” location on the intelligent controller, may be displayed on the desktop or may be located at any easily accessible reference point associated with the intelligent controller. It is also contemplated that desktop icons 602, 604, 606 and 608 may not require any loading of additional software or use of any additional intelligent controller hardware that is not commonly employed by a user of an intelligent controller. Specifically, by activating desktop icon 602 a user is able to directly access the desired CD-ROM. Alternatively, a user may directly access the desired DVD by depressing desktop icon 604 or the desired web-page by depressing desktop icon 606 or another source of electronic media by activating desktop icon 608. For example, by first activating at least one of desktop icons 602, 604, 606 or 608 with a mouse-type device, a user may be presented with a separate pop-up screen or an overlay screen, direct link screen or other like window display 314. Window display 314 provides the user with a second opportunity to directly link to the desired electronic address. Herein, as depicted, a user is provided the opportunity to make a second selection by utilizing a data entry means such as a mouse device. For example, the user may activate navigation indicia 610 to be directed to selections for electronic media related to “Chapter 1, Introduction to Biology.” Alternatively, the user may activate navigation indicia 612 to be directed to selections for electronic media related to “Chapter 2, Cells,” navigation indicia 614 to be directed to selections for electronic media related to “Chapter 3, Nervous System,” or navigation indicia 616 to be directed to selections for electronic media related to “Chapter 4, Circulatory System. Although only four navigation indicia 610, 612, 614 and 616 are provided for exemplary purposes, it is contemplated by the present invention that navigation indicia may consist of any multitude of entries arranged in any comprehensible order that relate to the structure of the corresponding printed matter.

Upon activating navigation indicia 610, 612, 614 or 616 a user may then be directed to a third screen as depicted in FIG. 6B wherein a user is provided another set of navigation indicia 620, 622, 624, 626, 628 and 630. For example, navigation indicia may represent, but not be limited to “videos,” 620, “quizzes” 622, “bulletin board” 624, “glossary” 626, “references” 628 and “web links” 630. Therefore, upon activating navigation indicia 620, 622, 624, 626, 628 or 630 a user may be directed a series of videos, quizzes or other electronic media corresponding to the printed matter.

Upon activating navigation indicia 620, 622, 624, 626, 628 or 630 a user may be directed to a fourth screen as depicted in FIG. 6C. For example, navigation indicia 634, 636, 638 and 640 may include, but not be limited to “video A,” “video B,” “video C,” or “video D.” Therefore, upon activating navigation indicia 634, 636, 638 or 640 a user may be directed a series of videos corresponding to the printed matter.

Therefore, if a user is perusing a Biology textbook and desires to access additional information relating to the textbook, the user may be provided the opportunity to directly link to the desired additional sources of information. For example, if a user is presented with an electronic address of “CD,” “Chapter 1, Introduction to Biology,” “V,” and “A,” in the printed Biology textbook, the user is simply required to activate four buttons. Specifically, in order to access the desired address a user must only activate desktop icon 602 for “CD,” navigation indicia 610 for “Chapter 1, Introduction to Biology,” navigation indicia 620 for “V” (i.e., videos) and navigation indicia 634 for “A” (i.e., video A or the first video in the section. Therefore, the user may quickly access the first video of Chapter 1 located on the CD-ROM with four clicks of a mouse. This embodiment allows the user to quickly access the desired electronic media without inputting extensive program entries or lengthy web addresses that are currently required. Specifically, this embodiment of the present invention provides the user an opportunity to quickly and efficiently link to a desired electronic address with a series of four simple data entries (i.e., “click” of a mouse device, depression of a keyboard or other like means for entering data).

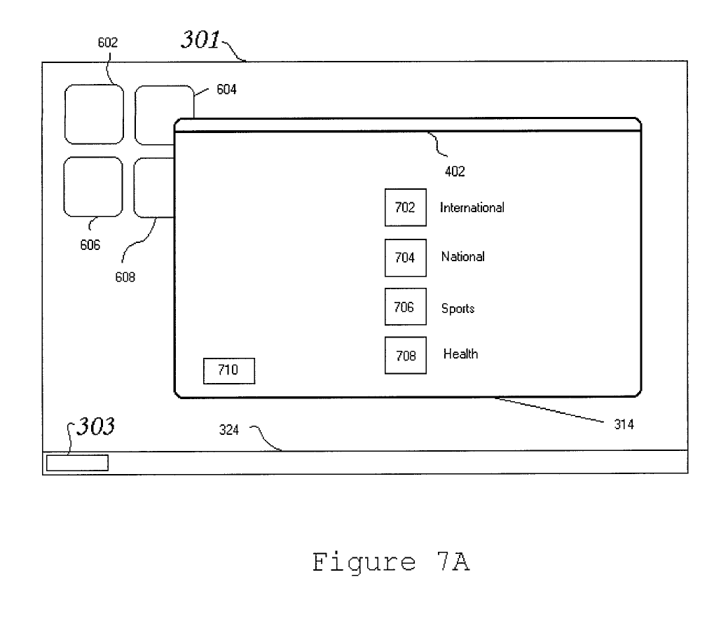

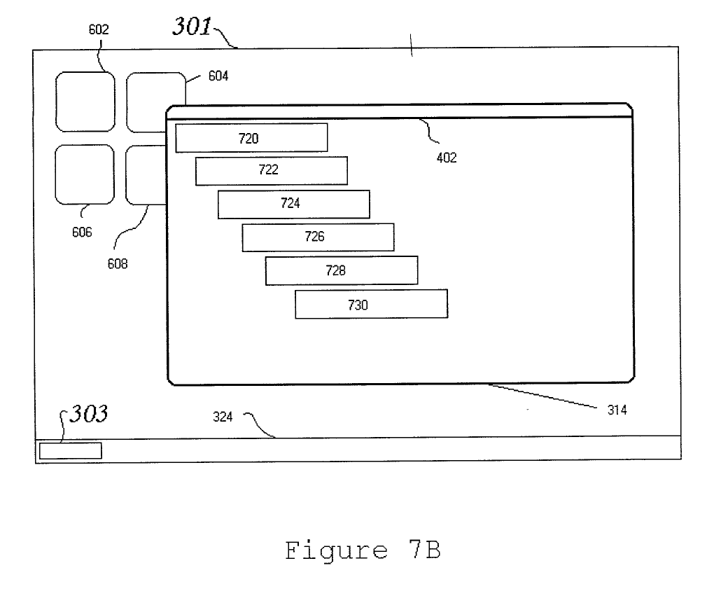

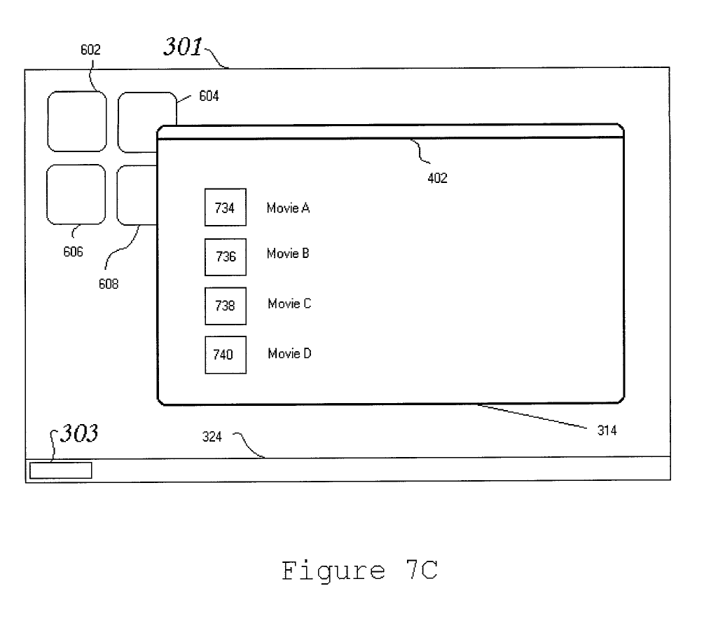

Referring next to FIGS. 7A, 7B and 7C, depicted is another example of an alternate embodiment of the present invention pertaining to a printed periodical (not shown) wherein computer display screen 301 comprises desktop icons 602, 604, 606 and 608, menu bar 324, and menu button 303 as found in most user-friendly computer operating systems wherein a mouse (not shown) provides the user with simplified control of a multitude of computer functions. As depicted in a corresponding printed matter (i.e., a printed periodical), a user is provided four indicia for direction to a desired electronic address for additional information relating to the text set forth in the printed matter. In this embodiment, desktop top icons 602, 604, 606 and 608 consist of specific direct links to the desired sources of electronic media relating to the printed matter. Specifically, by activating desktop icon 602 a user is able to directly access the desired CD-ROM. Alternatively, a user may directly access the desired DVD by depressing desktop icon 604 or the desired web page by depressing desktop icon 606 or another source of electronic media by activating desktop icon 608. For example, by first activating at least one of desktop icons 602, 604, 606 or 608 with a mouse-type device, a user may be presented with a separate pop-up screen, an overlay screen, direct link screen or other like window display 314. Window display 314 provides the user with a second opportunity to directly link to the desired electronic address. Herein, a user is provided the opportunity to make a second selection by utilizing a data entry means such as a mouse device. For example, the user may activate navigation indicia 702 to be directed to selections for electronic media related to “International articles.” Alternatively, the user may activate navigation indicia 704 to be directed to selections for electronic media related to “National articles,” navigation indicia 706 to be directed to selections for electronic media related to “Sports articles,” or navigation indicia 708 to be directed to selections for electronic media related to “Health articles.” Although only four navigation indicia 702, 704, 706 and 708 are provided for exemplary purposes, it is contemplated by the present invention that navigation indicia may consist of any multitude of entries arranged in any comprehensible order that relate to the structure of the corresponding printed matter. For example, it is foreseeable the printed matter may be further categorized according to title, date of publication any additional means for categorizing similar publications.

Upon activating navigation indicia 702, 704, 706 or 708 a user may then be directed to a third screen as depicted in FIG. 7B wherein a user is provided another set of navigation indicia 720, 722, 724, 726, 728 and 730. For example, navigation indicia may represent, but not be limited to “videos,” 720, “quizzes” 722, “bulletin board” 724, “glossary” 726, “movies” 728 and “web links” 730. Therefore, upon activating navigation indicia 720, 722, 724, 726, 728 or 730 a user may be directed a series of videos, quizzes or other electronic media corresponding to the printed matter.

Upon activating navigation indicia 720, 722, 724, 726, 728 or 730 a user may be directed to a fourth screen as depicted in FIG. 7C. For example, navigation indicia 734, 736, 738 and 740 may include, but not be limited to “movie A,” “movie B,” “movie C,” or “movie D.” Therefore, upon activating navigation indicia 734, 736, 738 or 740 a user may be directed a series of citations corresponding to the printed matter.

Therefore, if a user is perusing a national periodical and desires to access additional information relating to the publication, the user may be provided the opportunity to directly link to the desired additional sources of information. For example, if a user is presented with an electronic address of “www,” “National articles,” “M,” and “1,” in the printed publication, the user is simply required to activate four buttons. Specifically, in order to access the desired address a user must only activate “desktop icon” 606 for “www,” navigation indicia 704 for “National articles,” navigation indicia 728 for “M” (i.e., movies) and navigation indicia 734 for “1” (i.e., first movie of the section.) Therefore, the user may quickly access the first movie of the movie section related to National section located on the world-wide-web with four simple clicks of a mouse. These “clicks” take the user swiftly to electronic audiovisual material on the world-wide-web that provides more information about the subject being discussed in the printed matter. This embodiment allows the user to quickly access the desired electronic media without inputting extensive program entries or lengthy web addresses that are currently required. Specifically, this embodiment of the present invention provides the user an opportunity to quickly and efficiently link to a desired electronic address with a series of four simple data entries (i.e., “click” of a mouse device, depression of a keyboard or other like means for entering data).

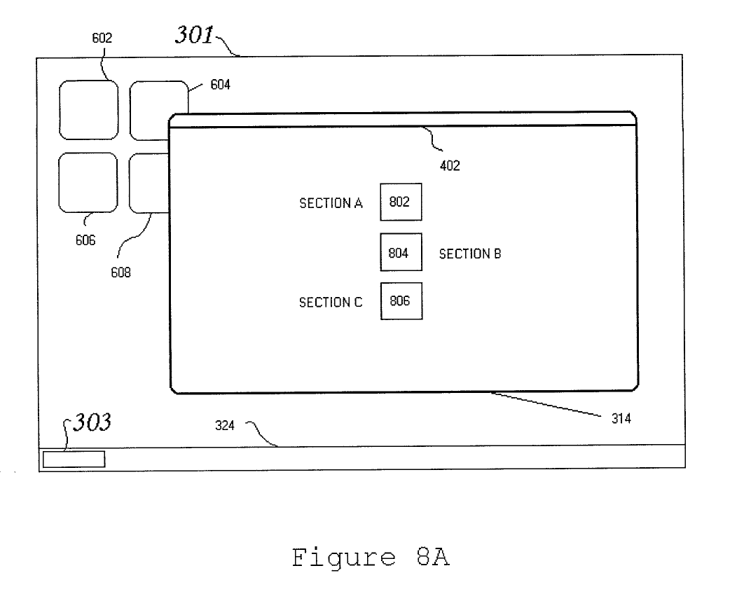

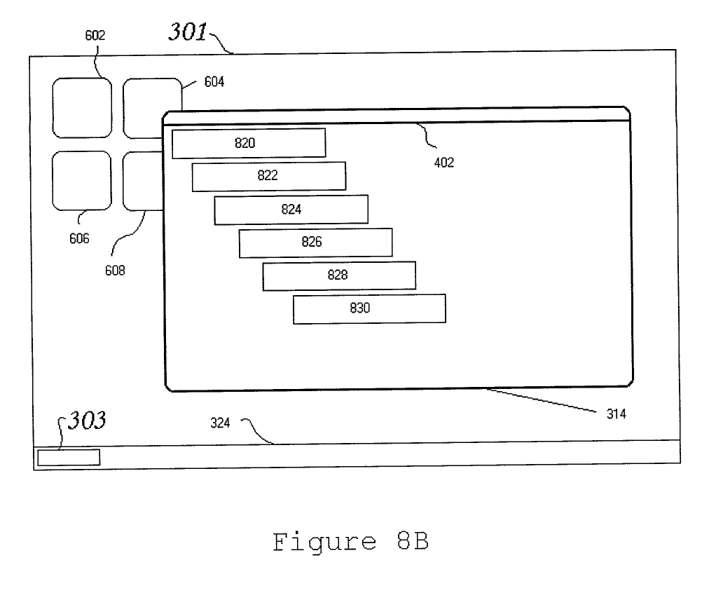

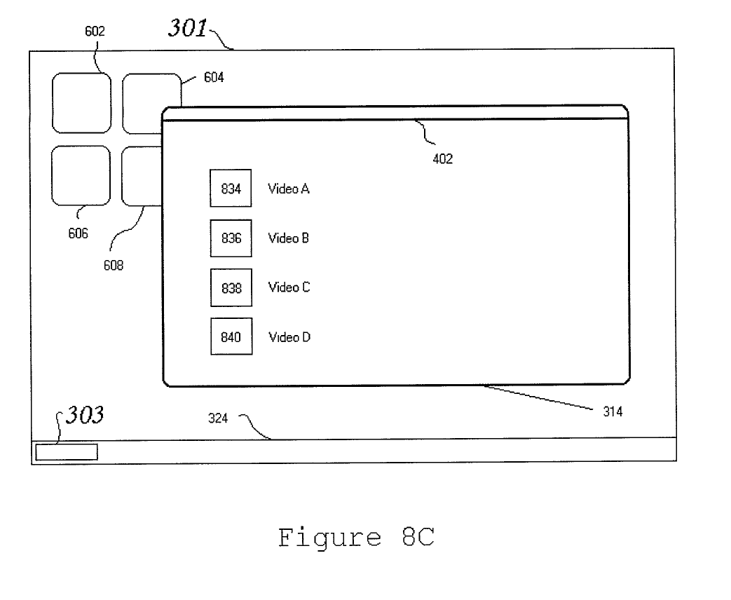

Referring next to FIGS. 8A, 8B and 8C, depicted is another example of an alternate embodiment of the present invention pertaining to a printed newspaper (not shown) wherein computer display screen 301 comprises “desktop icons” 602, 604, 606 and 608, menu bar 324, and menu button 303 as found in most user-friendly computer operating systems wherein a mouse (not shown) provides the user with simplified control of a multitude of computer functions. As depicted in a corresponding printed matter (i.e., a printed newspaper), a user is provided four indicia for direction to a desired electronic address for additional information relating to the text set forth in the printed matter. In this embodiment, desktop top icons consist of specific direct links to the desired sources of electronic media relating to the printed matter. Specifically, by activating desktop icon 602 a user may be able to directly access the desired CD-ROM. Alternatively, a user may directly access the desired DVD by depressing desktop icon 604 or the desired web page by depressing desktop icon 606 or another source of electronic media by activating desktop icon 608. For example, by first activating at least one of desktop icons 602, 604, 606 or 608 with a mouse-type device, a user may be presented with a separate pop-up screen, an overlay screen, direct link screen or other window display. Window display 314 provides the user with a second opportunity to directly link to the desired electronic address. Herein, a user is provided the opportunity to make a second selection by utilizing a data entry means such as a mouse device. For example, the user may activate navigation indicia 802 to be directed to selections for electronic media related to “Section A.” Alternatively, the user may activate navigation indicia 804 to be directed to selections for electronic media related to “Section B,” or navigation indicia 806 to be directed to selections for electronic media related to “Section C.” Although only three navigation indicia 802, 804 and 806 are provided for exemplary purposes, it is contemplated by the present invention that navigation indicia may consist of any multitude of entries arranged in any comprehensible order that relate to the structure of the corresponding printed matter. For example, it is foreseeable the publications may be further categorized according to title, date of publication any additional means for categorizing similar publications.

Upon activating navigation indicia 802, 804 or 806 a user may then be directed to a third screen as depicted in FIG. 8B wherein a user is provided another set of navigation indicia 820, 822, 824, 826, 828 and 830. For example, navigation indicia may represent, but not be limited to “videos,” 820, “quizzes” 822, “bulletin board” 824, “glossary” 826, “references” 828 and “web links” 830. Therefore, upon activating navigation indicia 820, 822, 824, 826, 828 or 830 a user may be directed a series of videos, quizzes or other electronic media corresponding to the printed matter.

Upon activating navigation indicia 820, 822, 824, 826, 828 or 830 a user may be directed to a fourth screen as depicted in FIG. 8C. For example, navigation indicia 834, 836, 838 and 840 may include, but not be limited to “video A,” “video B,” “video C,” or “video D.” Therefore, upon activating navigation indicia 834, 836, 838 or 840 a user may be directed to a series of videos corresponding to the printed matter.

Therefore, if a user is perusing a printed newspaper and desires to access additional information relating to the newspaper, the user may be provided the opportunity to directly link to the desired additional sources of information. For example, if a user is presented with an electronic address of “www,” “Section B,” “V,” and “C,” in the printed newspaper, the user is simply required to activate four buttons. Specifically, in order to access the desired address a user must only activate desktop icon 606 for “www,” navigation indicia 804 for “Section B,” navigation indicia 820 for “V” (i.e., videos) and navigation indicia 838 for “C” (i.e., third video in the section.) Therefore, the user may quickly access the third video of Section B on the world-wide-web with four simple clicks of a mouse. This embodiment allows the user to quickly access the desired electronic media without inputting extensive program entries or lengthy web addresses that are currently required. Specifically, this embodiment of the present invention provides the user an opportunity to quickly and efficiently link to a desired electronic address with a series of four simple data entries (i.e., “click” of a mouse device, depression of a keyboard or other like means for entering data).

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

We claim:

1. A method of linking printed matter to digital media comprising the steps of:
a.) providing a printed matter having associated therewith at least one navigation indicia wherein said navigation indicia is representative of a link to a portion of said electronic media;
b.) inputting said navigation indicia into an intelligent controller;
c.) accessing said electronic media.

2. A method as defined in claim 1 wherein said navigation indicia is inputted by use of a digital mouse.

3. A method as defined in claim 1 wherein said navigation indicia is inputted by use of an optical mouse.

4. A method as defined in claim 1 wherein said navigation indicia is inputted by use of a keyboard.

5. A method as defined in claim 1 wherein said navigation indicia is inputted by use of a touch-screen.

6. A system for displaying electronic media to a user, comprising:
a printed matter having associated therewith at least one navigation indicia;
an intelligent controller having associated therewith an input means for inputting said navigation indicia into a navigation link entry box for directing said intelligent controller to access said electronic media;
wherein said navigation indicia is representative of a link to a portion of said electronic media.

7. A system as defined in claim 6 wherein said input means comprises a digital mouse.

8. A system as defined in claim 6 wherein said input means comprises an optical mouse.

9. A system as defined in claim 6 wherein said input means comprises a keyboard.

10. A system as defined in claim 6 wherein said input means comprises a touch-screen.

11. A method of linking printed matter to digital media comprising the steps of:
a.) providing a printed matter having associated therewith at least one navigation indicia wherein said navigation indicia is representative of a link to a portion of said electronic media;
b.) inputting said navigation indicia into an intelligent controller;
c.) accessing said electronic media;
d.) accessing a page associated with said electronic media
wherein said electronic media supplements the text of said printed matter.

12. A method as defined in claim 11 wherein said navigation indicia is inputted by use of a digital mouse.

13. A method as defined in claim 11 wherein said navigation indicia is inputted by use of an optical mouse.

14. A method as defined in claim 11 wherein said navigation indicia is inputted by use of a keyboard.

15. A method as defined in claim 11 wherein said navigation indicia is inputted by use of a touch-screen.
